(19) United States
(12) Patent Application Publication
(10) Pub. No.: US 2007/0240426 A1
(43) Pub. Date: Oct. 18, 2007

(54) Mehtod and controller for operating a gas turbine engine

(75) Inventors: Herman Lucas Norbert Wiegman, Niskayuna, NY (US); Karl Edward Sheldon, Rexford, NY (US); John Biagio Turco, West Chester, OH (US); William Carlson, Liberty Township, OH (US)

Correspondence Address: GENERAL ELECTRIC COMPANY, GE AVIATION, ONE NEUMANN WAY MD H17, CINCINNATI, OH, 45215, US

(73) Assignee: General Electric Company

(21) Appl. No.: 11/402,477

(22) Filed: Apr. 12, 2006

(51) Int. Cl. F02C 9/00

(52) U.S. Cl. 60/793

(57) ABSTRACT

A controller for operating a gas turbine engine, wherein the gas turbine engine is installable in an installation platform, wherein the gas turbine engine includes a compressor, a turbine, and a shaft connecting the turbine to the compressor. The controller includes a program which instructs the controller to run a computer dynamic model of the gas turbine engine, wherein the computer dynamic model has inputs including engine operating conditions and installation platform operating conditions. The controller also is programmed to calculate a dynamic limit on mechanical power extraction from the shaft based at least on the running of the computer dynamic model of the gas turbine engine. A method for operating a gas turbine engine installed in an aircraft includes running a computer dynamic model of the engine and calculating a dynamic limit on mechanical power extraction from a shaft of the engine based at least on the running of the model.

### BACKGROUND OF THE INVENTION

The present invention relates generally to gas turbine engines, and more particularly to a method and to a controller for operating a gas turbine engine.

Gas turbine engines include gas turbine engines used for aircraft propulsion. A conventional aircraft gas turbine engine includes, among other components, a compressor, a high pressure turbine, and a high pressure shaft connecting the high pressure turbine to the compressor. Combustion gases exiting the gas turbine engine provide at least some of the thrust generated by the engine. For those gas turbine engines also having a low pressure shaft connecting a low pressure turbine to a fan, additional thrust is provided by air exiting the fan duct. At times, an engine controller commands that bleed air be extracted from the compressor for various purposes as are known to the artisan. At times, the engine controller commands that mechanical power be extracted from the high pressure shaft (either directly or through an accessory gearbox) to rotate an electric generator to produce electricity used by the aircraft and/or to rotate a hydraulic or pneumatic pump in the aircraft. Engineers run a computer dynamic model of the gas turbine engine, simulating worst case engine and aircraft operating conditions as inputs, to arrive at a fixed limit on the maximum mechanical power to be extracted from the high pressure shaft, wherein the fixed limit is chosen to prevent stall of the engine under all engine and aircraft operating conditions.

Conventional gas turbine engines are also installed on other installation platforms such as, without limitation, a helicopter, a ship, an electrical power generation plant, a locomotive, a pumping station, and a tank.

Still, scientists and engineers continue to seek improved methods and improved controllers for operating a gas turbine engine.

### BRIEF DESCRIPTION OF THE INVENTION

A method of the invention is for operating a gas turbine engine installed in an aircraft, wherein the gas turbine engine includes a compressor, a turbine, and a shaft connecting the turbine to the compressor. The method includes running a computer dynamic model of the gas turbine engine, wherein the computer dynamic model has inputs including engine operating conditions of the gas turbine engine and aircraft operating conditions of the aircraft. The method also includes calculating a dynamic limit on mechanical power extraction from the shaft based at least on the running of the computer dynamic model of the gas turbine engine.

A first expression of an embodiment of the invention is for a controller for operating a gas turbine engine installed in an aircraft, wherein the gas turbine engine includes a compressor, a turbine, and a shaft connecting the turbine to the compressor. The controller includes a program which instructs the controller to run a computer dynamic model of the gas turbine engine, wherein the computer dynamic model has inputs including engine operating conditions of the gas turbine engine and aircraft operating conditions of the aircraft. The controller also is programmed to calculate a dynamic limit on mechanical power extraction from the shaft based at least on the running of the computer dynamic model of the gas turbine engine.

A second expression of an embodiment of the invention is for a controller for operating a gas turbine engine, wherein the gas turbine engine is installable in an installation platform, wherein the gas turbine engine includes a compressor, a turbine, and a shaft connecting the turbine to the compressor. The controller includes a program which instructs the controller to run a computer dynamic model of the gas turbine engine, wherein the computer dynamic model has inputs including engine operating conditions of the gas turbine engine and installation platform operating conditions of the installation platform. The controller also is programmed to calculate a dynamic limit on mechanical power extraction from the shaft based at least on the running of the computer dynamic model of the gas turbine engine.

### BRIEF DESCRIPTION OF THE DRAWINGS

The accompanying drawings illustrate a method and an embodiment of the invention wherein:

FIG. 1 is a block diagram of a method for operating a gas turbine engine;

FIG. 2 is a schematic view of an embodiment of an aircraft including a gas turbine engine which, in one example, is operated by the method of FIG. 1; and

FIG. 3 is a schematic view of the gas turbine engine of FIG. 2 including a compressor, a turbine, and a shaft, together with a controller programmed for operating the gas turbine engine, a valve commanded by the controller for bleed air extraction from the compressor, and an electric generator operatively connected to the shaft through an accessory gearbox which is commanded by the controller to enable the electric generator to extract mechanical power from the shaft.

### DETAILED DESCRIPTION OF THE INVENTION

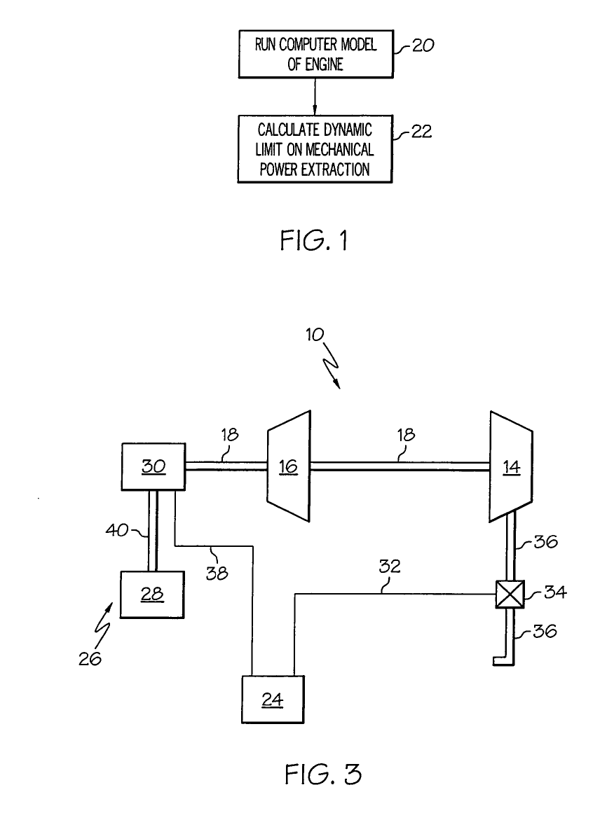

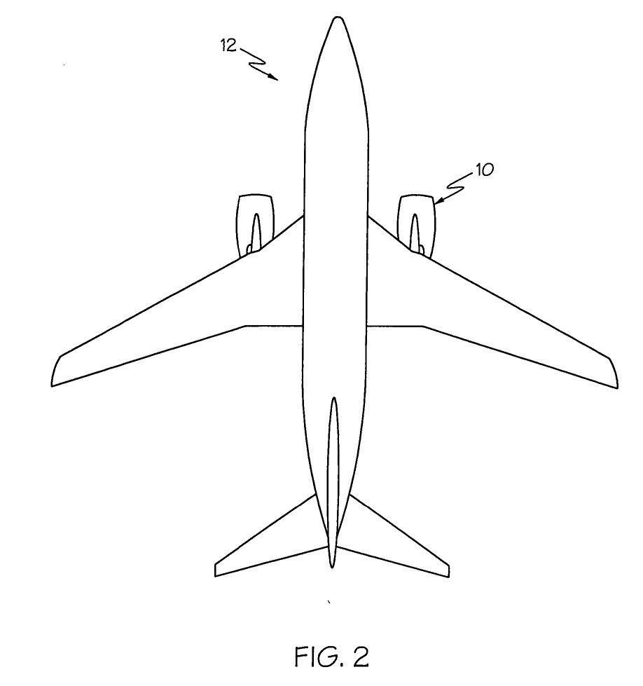

Referring now to the drawings, FIG. 1 discloses a method of the invention for operating a gas turbine engine 10 installed in an aircraft 12, such as, but not limited to, an embodiment thereof disclosed in FIGS. 2 and 3. The gas turbine engine 10 of the method includes a compressor 14, a turbine 16, and a shaft 18 connecting the turbine 16 to the compressor 14. The method includes, as indicated by a block labeled 20 in FIG. 1, running a computer dynamic model of the gas turbine engine 10, wherein the computer dynamic model has inputs including engine operating conditions of the gas turbine engine 10 and aircraft operating conditions of the aircraft 12. The method also includes, as indicated by a block labeled 22 in FIG. 1, calculating a dynamic limit on mechanical power extraction from the shaft 18 based at least on the running of the computer dynamic model of the gas turbine engine 10. In a first example, the computer dynamic model of the gas turbine engine 10 is run in real time onboard the aircraft 12. In a second example, the computer dynamic model of the gas turbine engine 10 is run, but not in real time onboard the aircraft 12, wherein the method calculates a plurality of different values of the dynamic limit based at least on the running of the computer dynamic model, wherein the different values of the dynamic limit correspond to different values of the inputs to the computer dynamic model. In one variation, the different values of the inputs and the corresponding different values of the dynamic limit are stored in a lookup table. Other examples are left to those skilled in the art.

In one enablement, the method also includes extracting mechanical power from the shaft 18 at a level not exceeding the calculated dynamic limit on mechanical power extraction. In one variation, the method also includes calculating a dynamic rate limit on bleed air extraction from the compressor 14 based at least on the running of the computer dynamic model of the gas turbine engine 10. In one modification, the method also includes extracting bleed air from the compressor 14 at a rate not exceeding the calculated dynamic rate limit on bleed air extraction. In one example, the dynamic rate limit on bleed air extraction and the dynamic limit on mechanical power extraction are calculated to prevent a stall of the gas turbine engine 10. It is noted that creating and running such a computer dynamic model of a gas turbine engine installed in an aircraft, calculating such dynamic limit on mechanical power extraction and such dynamic rate limit on bleed air extraction, and such extracting of mechanical power and bleed air is within the ordinary capabilities of those skilled in the art.

A first expression of an embodiment of the invention is for a controller 24 for operating a gas turbine engine 10 installed in an aircraft 12, wherein the gas turbine engine 10 includes a compressor 14, a turbine 16, and a shaft 18 connecting the turbine 16 to the compressor 14. The controller 24 includes a program which instructs the controller 24 to run a computer dynamic model of the gas turbine engine 10, wherein the computer dynamic model has inputs including engine operating conditions of the gas turbine engine 10 and aircraft operating conditions of the aircraft 12. The controller 24 also is programmed to calculate a dynamic limit on mechanical power extraction from the shaft 18 based at least on the running of the computer dynamic model of the gas turbine engine 10. It is noted that the expression “The controller 24 is programmed to . . . ” is equivalent to “The program also instructs the controller 24 to . . . ”.

In one enablement of the first expression of an embodiment of the invention, the controller 24 also is programmed to command extracting mechanical power from the shaft 18 at a level not exceeding the calculated dynamic limit on mechanical power extraction. In one variation, the controller 24 also is programmed to calculate a dynamic rate limit on bleed air extraction from the compressor 14 based at least on the running of the computer dynamic model of the gas turbine engine 10. In one modification, the controller 24 also is programmed to command extracting bleed air from the compressor 14 at a rate not exceeding the calculated dynamic rate limit on bleed air extraction. In one example, the dynamic rate limit on bleed air extraction and the dynamic limit on mechanical power extraction are calculated to prevent a stall of the gas turbine engine 10.

In one application of the first expression of an embodiment of the invention, the mechanical power extraction is extracted by at least one mechanical power extraction device 26 operatively connected to the shaft 18. In one variation, at least one of the at least one mechanical power extraction device 26 is chosen from the group consisting of an electric generator 28, a hydraulic pump, and a pneumatic pump. In one modification, at least one of the at least one mechanical power extraction device 26 is operatively connected to the shaft 18 through an accessory gearbox 30. In another modification, not shown, at least one of the at least one mechanical power extraction device is directly connected to the shaft 18. Other examples of mechanical power extraction devices and shaft connections are left to the artisan.

In one employment of the first expression of an embodiment of the invention, the engine operating conditions inputted into the computer dynamic model of the gas turbine engine 10 include, without limitation, engine temperatures and/or gas (including air and combustion gases), pressures at various locations in the gas turbine engine 10, rotational speed of the shaft 18, angle settings of inlet guide vanes and/or compressor variable stator vanes, and/or exhaust flaps, etc. In the same or a different employment, the aircraft operating conditions inputted into the computer dynamic model of the gas turbine engine 10 include, without limitation, aircraft altitude, aircraft air speed, aircraft attitude such as aircraft pitch angle and/or aircraft yaw angle with respect to the air stream, propulsion demands such as engine throttle setting, and mechanical power and bleed air extraction demands.

In one implementation of the first expression of an embodiment of the invention, the calculated dynamic limit on mechanical power extraction and/or the calculated dynamic rate limit on bleed air varies in steps over time based at least on time variations in engine operating conditions and aircraft operating conditions as reflected through the running of the computer dynamic model of the gas turbine engine 10 over time. In another implementation, the calculated dynamic limit and/or the calculated dynamic rate limit varies continuously over time. It is noted, for example, that under certain operating conditions higher limits on extracting mechanical power from the shaft 18 are permitted without incurring an engine stall than for other operating conditions, such limit determination being within the ordinary capabilities of those skilled in the art. Thus, in one illustration, a technical effect is that the controller 24 provides for more mechanical power extraction from the shaft 18 over a flight time of the aircraft 12 than is provided by conventionally using a fixed limit on the maximum mechanical power wherein such fixed limit is chosen to prevent stall of the engine under all engine and aircraft operating conditions.

In one arrangement of the first expression of an embodiment of the invention, as shown in FIG. 3, the controller 24 is connected, through a first signal command line 32, to a valve 34 in a bleed-air conduit 36 and is connected to the accessory gearbox 30 through a second signal command line 38. The accessory gearbox 30 is commanded by the controller 24, through the second signal command line 38, to enable the electric generator 28, through its drive shaft 40, to extract mechanical power from the shaft 18. It is noted that the combustor and other essential and optional components of the gas turbine engine 10, as well as engine and aircraft operating condition signal inputs to the controller 24 and other outputs from the controller 24, have been omitted from FIG. 3 for clarity but are well known to the artisan.

As can be appreciated by the artisan, a second and broader expression of an embodiment of the invention is for a controller 24 for operating a gas turbine engine 10, wherein the gas turbine engine 10 is installable in an installation platform 32, wherein the gas turbine engine 10 includes a compressor 14, a turbine 16, and a shaft 18 connecting the turbine 16 to the compressor 14. The controller 24 includes a program which instructs the controller 24 to run a computer dynamic model of the gas turbine engine 10, wherein the computer dynamic model has inputs including engine operating conditions of the gas turbine engine 10 and installation platform operating conditions of the installation platform 32. The controller 24 also is programmed to calculate a dynamic limit on mechanical power extraction from the shaft 18 based at least on the running of the computer dynamic model of the gas turbine engine 10.

It is noted that the enablements, variations, applications, etc. (other than specifics relevant only to aircraft) of the first expression of an embodiment of the invention are equally applicable to the second expression of an embodiment of the invention with the term “aircraft” being replaced with “installation platform”. Examples of an installation platform (other than an aircraft serving as an installation platform) include, without limitation, a helicopter, a ship, an electrical power generation plant, a locomotive, a pumping station, and a tank.

While the present invention has been illustrated by a description of a method and several expressions of an embodiment, it is not the intention of the applicants to restrict or limit the spirit and scope of the appended claims to such detail. Numerous other variations, changes, and substitutions will occur to those skilled in the art without departing from the scope of the invention.

1. A method for operating a gas turbine engine installed in an aircraft, wherein the: gas turbine engine includes a compressor, a turbine, and a shaft connecting the turbine to the compressor, and wherein the method comprises:
running a computer dynamic model of the gas turbine engine, wherein the computer dynamic model has inputs including engine operating conditions of the gas turbine engine and aircraft operating conditions of the aircraft; and
calculating a dynamic limit on mechanical power extraction from the shaft based at least on the running of the computer dynamic model of the gas turbine engine.

2. The method of claim 1, also including extracting mechanical power from the shaft at a level not exceeding the calculated dynamic limit on mechanical power extraction.

3. The method of claim 2, also including calculating a dynamic rate limit on bleed air extraction from the compressor based at least on the running of the computer dynamic model of the gas turbine engine

4. The method of claim 3, also including extracting bleed air from the compressor at a rate not exceeding the calculated dynamic rate limit on bleed air extraction.

5. The method of claim 4, wherein the dynamic rate limit on bleed air extraction and the dynamic limit on mechanical power extraction are calculated to prevent a stall of the gas turbine engine.

6. A controller for operating a gas turbine engine installed in an aircraft, wherein the gas turbine engine includes a compressor, a turbine, and a shaft connecting the turbine to the compressor, and wherein the controller includes a program which instructs the controller to:
a) run a computer dynamic model of the gas turbine engine, wherein the computer dynamic model has inputs including engine operating conditions of the gas turbine engine and aircraft operating conditions of the aircraft; and
b) calculate a dynamic limit on mechanical power extraction from the shaft based at least on the running of the computer dynamic model of the gas turbine engine.

7. The controller of claim 6, wherein the controller also is programmed to command extracting mechanical power from the shaft at a level not exceeding the calculated dynamic limit on mechanical power extraction.

8. The controller of claim 7, wherein the controller also is programmed to calculate a dynamic rate limit on bleed air extraction from the compressor based at least on the running of the computer dynamic model of the gas turbine engine

9. The controller of claim 8, wherein the controller also is programmed to command extracting bleed air from the compressor at a rate not exceeding the calculated dynamic rate limit on bleed air extraction.

10. The controller of claim 9, wherein the dynamic rate limit on bleed air extraction and the dynamic limit on mechanical power extraction are calculated to prevent a stall of the gas turbine engine.

11. The controller of claim 7, wherein the mechanical power extraction is extracted by at least one mechanical power extraction device operatively connected to the shaft.

12. The controller of claim 11, wherein at least one of the at least one mechanical power extraction device is chosen from the group consisting of an electric generator, a hydraulic pump, and a pneumatic pump.

13. The controller of claim 11, wherein at least one of the at least one mechanical power extraction device is operatively connected to the shaft through an accessory gearbox.

14. A controller for operating a gas turbine engine, wherein the gas turbine engine is installable in an installation platform, wherein the gas turbine engine includes a compressor, a turbine, and a shaft connecting the turbine to the compressor, and wherein the controller includes a program which instructs the controller to:
a) run a computer dynamic model of the gas turbine engine, wherein the computer dynamic model has inputs including engine operating conditions of the gas turbine engine and installation platform operating conditions of the installation platform; and
b) calculate a dynamic limit on mechanical power extraction from the shaft based at least on the running of the computer dynamic model of the gas turbine engine.

15. The controller of claim 14, wherein the dynamic limit on mechanical power extraction is calculated to prevent a stall of the gas turbine engine.

16. The controller of claim 15, wherein the controller also is programmed to command extracting mechanical power from the shaft at a level not exceeding the calculated dynamic limit on mechanical power extraction.

17. The controller of claim 16, wherein the installation platform is chosen from the group consisting of an aircraft, a helicopter, a ship, an electrical power generation plant, a locomotive, a pumping station, and a tank.

18. The controller of claim 16, wherein the mechanical power extraction is extracted by at least one mechanical power extraction device operatively connected to the shaft.

19. The controller of claim 18, wherein at least one of the at least one mechanical power extraction device is chosen from the group consisting of an electric generator, a hydraulic pump, and a pneumatic pump.

20. The controller of claim 18, wherein at least one of the at least one mechanical power extraction device is operatively connected to the shaft through an accessory gearbox.
